(19) United States
(12) Patent Application Publication
(10) Pub. No.: US 2012/0138650 A1
(43) Pub. Date: Jun. 7, 2012

(54) CUP HOLDER SUPPORTING DIFFERENT SIZED DIGITAL MEDIA PLAYERS

(76) Inventor: Michael J. Wilms, (US)

(21) Appl. No.: 12/957,639

(22) Filed: Dec. 1, 2010

(51) Int. Cl. B60R 11/00; F16M 13/00

(52) U.S. Cl. 224/545; 248/311.2

(57) ABSTRACT

A cup holder may be suitable to support a beverage container as well as both a relatively larger digital media player and a relatively smaller digital media player in an upright position.

### BACKGROUND

A. Field of Invention

This invention generally relates to methods and apparatuses concerning cup holders and more specifically relates to methods and apparatuses concerning a cup holder that is suitable to hold in upright positions different sized digital media players.

B. Description of the Related Art

In recent years the popularity of digital media players (DMPs), including IPods and MP3 players, has increased dramatically. DMPs, depending on the particular type and model, may be used to store music files, video files, photos, podcasts and other such digital media files.

One difficulty with DMPs is providing an appropriate place to support them when they are being used. This difficulty is magnified by the fact that DMPs come in various sizes.

In the automotive industry storage space is limited so accommodating DMPs is especially difficult. It is known to place DMPs in existing vehicle storage compartments such as trays and cup holders. The problem with vehicle storage compartments, however, is that they do not hold the DMPS in an upright position (the position where DMPs are most easily used) and they do not secure the DMPs—making it easy for them to slide around as the vehicle is operated.

To combat the problem with vehicle storage compartments, it is known to provide inserts that are positioned within a cup holder and that hold DMPs in an upright position. The inserts, however, cause problems of their own. One problem is that the inserts add cost for the DMP user. Another problem is that they are designed to accommodate one size of DMP—making them improper for different sized DMPs. Yet another problem with the inserts is that they must be removed from the cup holder before the cup holder can be used to support a beverage container. Once removed, the inserts must then be stored somewhere in the vehicle—complicating the limited storage space.

What is needed, then, is cup holder that can hold various sized DMPs in an upright position without the use of inserts.

### SUMMARY

According to one embodiment of this invention, a cup holder may comprise: a beverage container support surface for use in supporting an associated beverage container; and, a slot formed in the beverage container support surface. The cup holder may be suitable to hold in an upright position a first relatively larger associated digital media player that is supportable to the beverage container support surface. The cup holder may also be suitable to hold in an upright position a second relatively smaller associated digital media player that is supportable within the slot.

According to another embodiment of this invention, an apparatus may comprise: a vehicle component that is accessible within the passenger compartment of an associated vehicle; and, a cup holder mounted to the vehicle component. The cup holder may comprise: a beverage container support surface for use in supporting an associated beverage container; and, a slot formed in the beverage container support surface. The cup holder may be suitable to hold in an upright position a first relatively larger associated digital media player that is supportable to the beverage container support surface. The cup holder may also be suitable to hold in an upright position a second relatively smaller associated digital media player that is supportable within the slot.

According to yet another embodiment of this invention, a method may comprise the steps of: (A) providing a cup holder comprising: a beverage container support surface for use in supporting an associated beverage container; and, a slot formed in the beverage container support surface; (B) supporting a relatively larger digital media player to the beverage container support surface in an upright position; and, (C) supporting a relatively smaller digital media player within the slot in an upright position.

One advantage of this invention is that various sized DMPs can be supported in an upright position in a cup holder.

Another advantage of this invention is that DMPs can be supported without the use of inserts.

Yet another advantage of this invention is that the cup holder can be easily used to support a beverage container.

Other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective right side view of a vehicle.

FIG. 2 is perspective front facing view of the passenger compartment of the vehicle depicted in FIG. 1.

FIG. 3 is perspective back facing view of the passenger compartment of the vehicle depicted in FIG. 1.

FIG. 4 is top view of a cup holder.

FIG. 5 is sectional side view of a cup holder showing the upright angle UA.

FIG. 6 is sectional side view of a cup holder showing a relatively smaller DMP in an upright position.

FIG. 7 is sectional side view of a cup holder showing a relatively larger DMP in an upright position.

### DETAILED DESCRIPTION

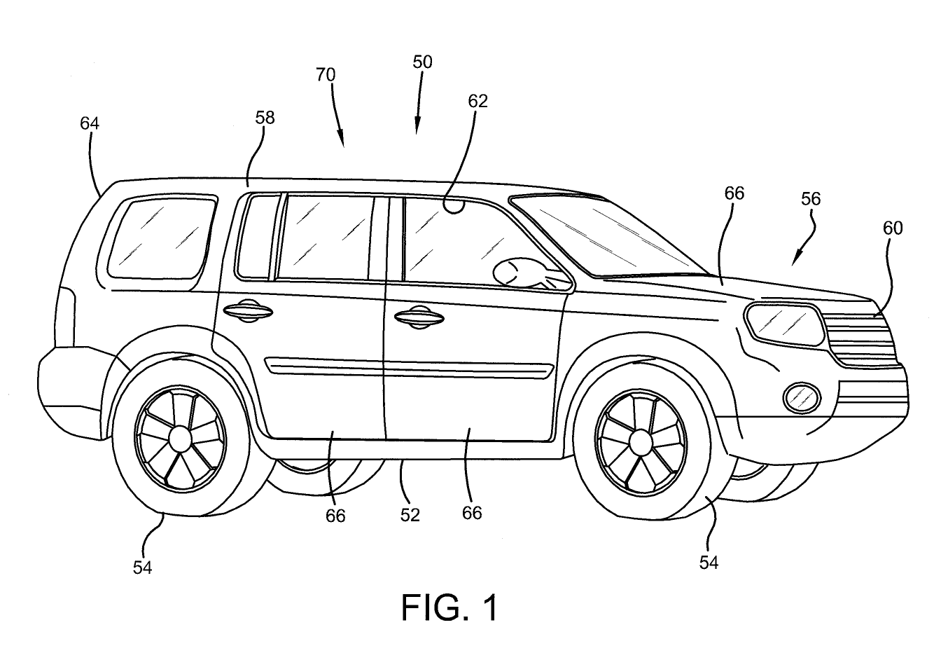

Referring now to the drawings wherein the showings are for purposes of illustrating embodiments of the invention only and not for purposes of limiting the same, and wherein like reference numerals are understood to refer to like components, FIG. 1 shows a vehicle 50 that may be equipped with one or more cup holders 70 according to this invention. While the vehicle 50 shown is an SUV (Sports Utility Vehicle), it is to be understood that the cup holder 70 of this invention will work with any vehicle chosen with the sound judgment of a person of skill in the art, including vans, sedans, off-road vehicles, airplanes and boats and may have non-vehicle applications as well. The vehicle 50 may include a frame 52, one or more ground engaging wheels 54 mounted to the frame 52, and a locomotion source 56, such as an engine or motor, mounted to the frame 52, for use in providing locomotion for the vehicle 50. The vehicle 50 may also have a body 58 mounted to the frame 52 that defines one or more compartments. The body may define, for some non-limiting examples, a locomotion compartment 60 that houses the locomotion source 56, a passenger compartment 62 that houses one or more passengers, and a luggage compartment 64 that may be used to house luggage or other cargo. The vehicle 50 may also have doors 66 that are moveable with respect to the body 58 between open positions granting access to the interior of the body (and thus providing access to one or more of the compartments 60, 62, 64) and closed positions preventing access to the interior of the body 58.

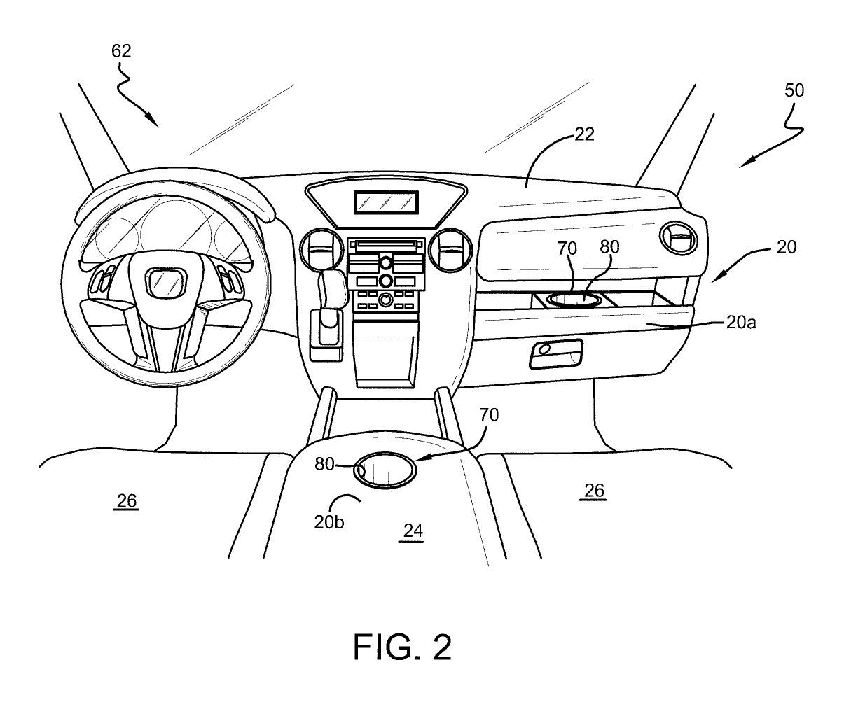

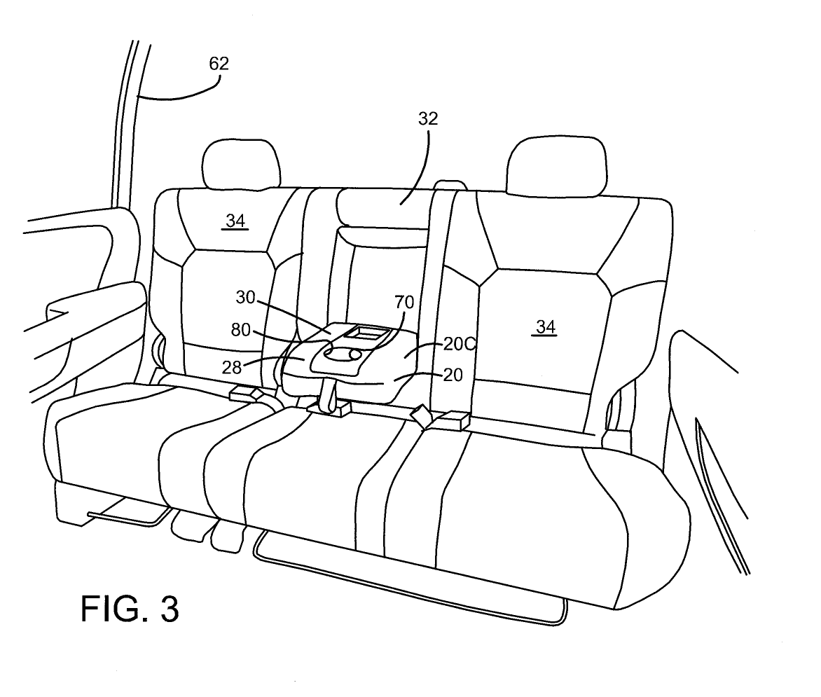

With reference now to FIGS. 1-3, the vehicle 50 may include one or more vehicle components 20, of any type, size and style chosen with the sound judgment of a person of skill in the art, that are accessible within the passenger compartment 62 and to which one or more cup holders 70 may be mounted. Some non-limiting examples of such vehicle components 20 include: a vehicle component 20a, shown in FIG. 2, attached to the dashboard (also known as an instrument panel) 22 on the front end of the passenger compartment 62; a vehicle component 20b, also shown in FIG. 2, attached to the center console 24 between a pair of front seats 26, 26; and, a vehicle component 20c, shown in FIG. 3, that is an armrest 28. The armrest 28 may have an outer surface 30 that is suitable to support a vehicle occupant's atm, as is well known in the art. For the embodiment shown, the armrest 28 is pivotally attached to a seatback 32 between a pair of seats 34, 34 in a middle row of seats. If the cup holder 70 is mounted to an armrest 28, however, the armrest can be of any type, size, style, and location chosen with the sound judgment of a person of skill in the art.

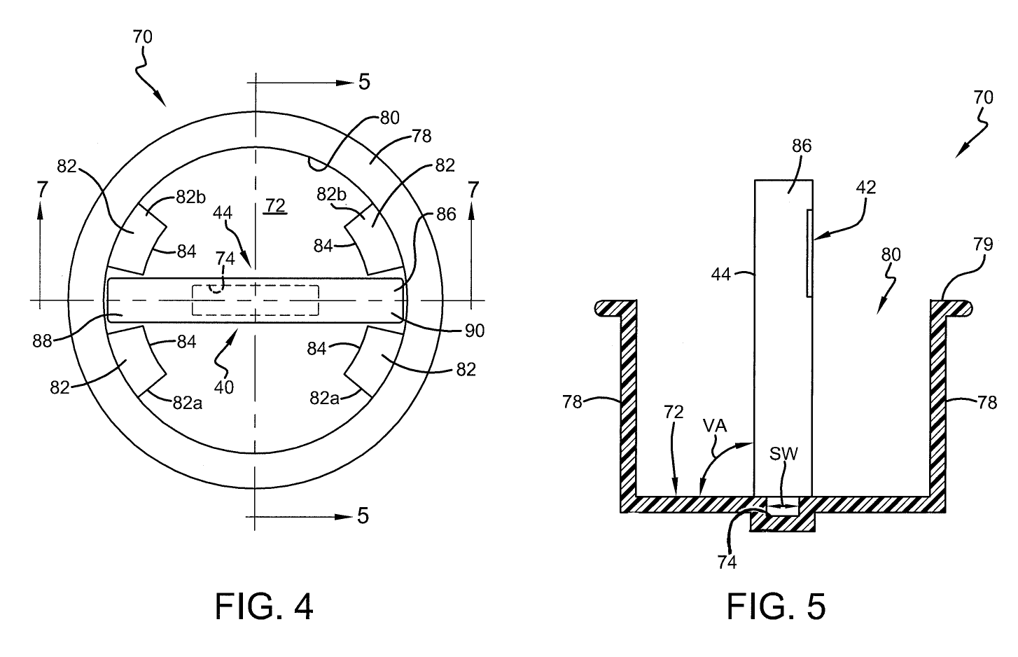

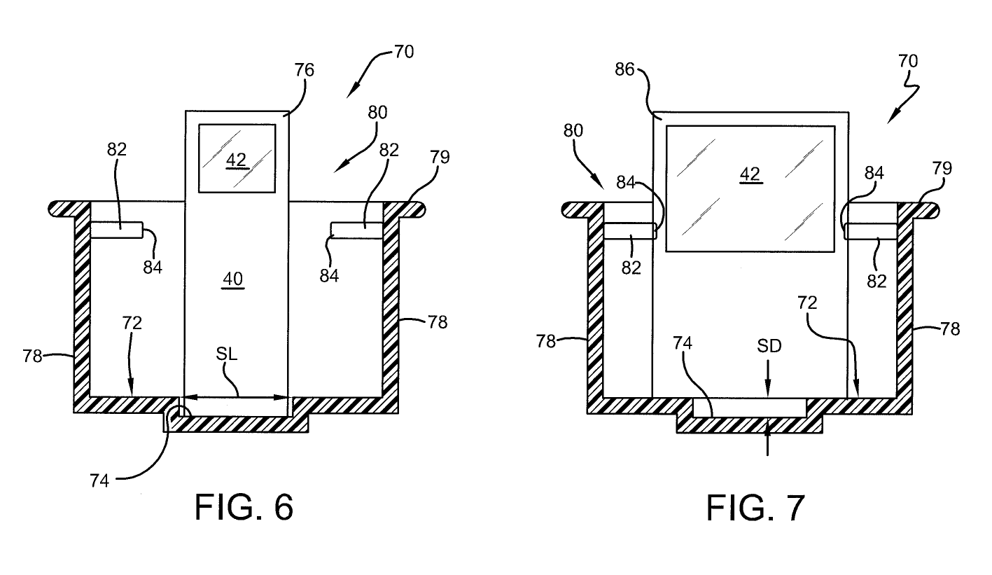

With reference now to FIGS. 4-7, the cup holder 70 may have a beverage container support surface 72 that supports a beverage container (not shown) as is well known to those of skill in the art. In what follows the holding or supporting of a digital media player (DMP) in an upright position will be described. To assist in defining the expression “upright position” it is noted that each DMP (a relatively smaller DMP 76 is shown in FIG. 6 and a relatively larger DMP 86 is shown in FIGS. 4, 5 and 7) has a front side 40. (the side that typically has a screen 42 that is used by the operator of the DMP as is well known to those of skill in the art) and a back side 44 (the side without the screen 42). Upright angle UA is defined as the angle between the back side 44 of the DMP and the beverage container support surface 72. An upright position is defined as the position of the DMP where the upright angle UA is at least 30 degrees. In a more specific embodiment, the upright angle UA may be at least 45 degrees. In an even more specific embodiment, the upright angle UA may be at least 75 degrees. For the embodiment shown, the upright angle UA is 90 degrees.

With continuing reference to FIGS. 4-7, the cup holder 70 may also include a slot 74 formed in the beverage container support surface 72, as shown. The slot 74 may have a length SL, a width SW and a depth SD sufficient to receive and support in an upright position the relatively smaller DMP 76 shown in FIG. 6. While the specific dimensions SL, SW and SD can be any chosen with the sound judgment of a person of skill in the art, in one embodiment, slot length SL is 1.5 inches, the slot width SW is 0.5 inches and the slot depth SD is 0.5 inches. While the slot 74 may also be positioned in any location on the beverage container support surface 72 chosen with the sound judgment of a person of skill in the art, for the embodiment shown the slot 74 is centered on the beverage container support surface 72.

With reference now to FIGS. 3-7, the cup holder 70 may have a sidewall structure 78 that extends from the beverage container support surface 72 and may define a cavity 80 that receives beverage containers as is well known to those of skill in the art and also receives the DMPs. In one embodiment, shown for example in FIG. 3, the cavity 80 may be formed in the corresponding vehicle component 20. While both the sidewall structure 78 and beverage container support surface 72 shown have circular cross-sections (see FIG. 4), it should be noted that other shapes also work well with this invention. If desired, the top of the sidewall structure 78 may have a lip 79. The cup holder 70 may also have one or more tabs 82, four shown, that extend from the sidewall structure 78 toward a center of the cavity 80. Each tab 82 may have a beverage container contact surface 84 for use in contacting the beverage container (not shown) to hold the beverage container within the cavity 80. While the tabs 82 can be positioned with respect to the sidewall structure 78 in any manner chosen with the sound judgment of a person of skill in the art, for the embodiment shown in FIG. 4, one pair of tabs 82, 82 are positioned on the opposite side of the cavity 80 from another pair of tabs 82, 82. The tabs 82 may be fixed with respect to the sidewall structure 78 or, in another embodiment, they may be movable with respect to the sidewall structure 78 to permit the cup holder 70 to hold various sized beverage containers. As the structure and operation of such tabs is well known to those of skill in the art, further details will not be provided here.

With reference now to FIG. 4, the relatively larger DMP 86 may be supported in an upright position on the beverage container support surface 72. If necessary, to assist in holding the relatively larger DMP 86 in the upright position, the DMP 82 may contact a portion of the sidewall structure 78 and/or a portion of one or more tabs 82. For the embodiment shown, a first portion 88 of the DMP 86 is positioned between one pair of the tabs 82, 82 and a second portion 90 of the DMP 86 is positioned between another pair of the tabs 82, 82. In one embodiment, shown in FIGURED 4 and 5, the DMP 86 may cover the slot 74 when the DMP 86 is in the upright position.

With reference now to all the FIGURES, the use of the cup holder 70 with DMPs will now be described. To support the relatively larger DMP 86 to the cup holder 70 in an upright position, it only necessary to remove any item that may be in the cup holder (such as a beverage container or other DMP) and then insert the DMP 86 within the cavity 80 against the beverage container support surface 72. No insert is required as with the prior art. If necessary, while inserting the DMP 86 into the cavity 80, one or both of the DMP 86 portions 88, 90 may be positioned between the tabs 82, 82. Depending on the position of the slot 74, the positioning of the DMP 86 onto the beverage container support surface 72 may cover the slot 82. To support the relatively smaller DMP 76 to the cup holder 70 in an upright position, it only necessary to remove any item that may be in the cup holder (such as a beverage container or other DMP) and then insert the DMP 76 within the cavity 80 and into the slot 74. The sides of the slot will maintain the DMP 76 in the upright position. No insert is required as with the prior art.

With reference now to FIGS. 4-7, while the upright positions of the DMPs described and shown so far maintain the DMPs 76, 86 at upright angles UA of 90 degrees, the upright angle UA can be altered as long as it supports the DMPs 76, 86 in an upright position as defined above. In one non-limiting example, the upright angle UA of the relatively smaller DMP 76 can be adjusted by altering the angles of the sides of the slot 74. In another non-limiting example, the upright angle UA of the relatively larger DMP 86 can be adjusted by leaning the DMP 86 away from two of the tabs (82a, 82a in FIG. 4) and leaning the back side 44 of the DMP 86 against two other of the tabs (82b, 82b in FIG. 4). The upright angle UA can be changed in any manner chosen with the sound judgment of a person of skill in the art.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A cup holder comprising:
a beverage container support surface for use in supporting an associated beverage container;
a slot formed in the beverage container support surface;
wherein the cup holder is suitable to hold in an upright position a first relatively larger associated digital media player that is supportable to the beverage container support surface; and,
wherein the cup holder is suitable to hold in an upright position a second relatively smaller associated digital media player that is supportable within the slot.

2. The cup holder of claim 1 further comprising:
a sidewall structure that extends from the beverage container support surface and defines a cavity for use in receiving: the associated beverage container; the first relatively larger associated digital media player; and, the second relatively smaller associated digital media player.

3. The cup holder of claim 2 further comprising:
first and second tabs extending from the sidewall structure toward a center of the cavity, each tab having a beverage container contact surface for use in contacting the associated beverage container to hold the associated beverage container within the cavity;
wherein a first portion of the first relatively larger associated digital media player is positionable between the first and second tabs to hold the first relatively larger associated digital media player in the upright position.

4. The cup holder of claim 3 further comprising:
third and fourth tabs extending from the sidewall structure toward a center of the cavity, each tab having a beverage container contact surface for use in contacting the associated beverage container to hold the associated beverage container within the cavity;
wherein a second portion of the first relatively larger associated digital media player is positionable between the third and fourth tabs to hold the first relatively larger associated digital media player in the upright position.

5. The cup holder of claim 2 wherein:
the sidewall structure has a substantially circular cross-section; and,
the beverage container support surface has a substantially circular cross-section.

6. The cup holder of claim 1 wherein:
the slot is substantially centered on the beverage container support surface.

7. The cup holder of claim 1 wherein:
the first relatively larger associated digital media player covers the slot when the first relatively larger associated digital media player is supported to the beverage container support surface.

8. An apparatus comprising:
a vehicle component that is accessible within the passenger compartment of an associated vehicle; and,
a cup holder mounted to the vehicle component, the cup holder comprising:
a beverage container support surface for use in supporting an associated beverage container;
a slot formed in the beverage container support surface;
wherein the cup holder is suitable to hold in an upright position a first relatively larger associated digital media player that is supportable to the beverage container support surface; and,
wherein the cup holder is suitable to hold in an upright position a second relatively smaller associated digital media player that is supportable within the slot.

9. The apparatus of claim 8 wherein:
the vehicle component is attached to an associated dashboard on the front end of the associated passenger compartment.

10. The apparatus of claim 8 wherein:
the vehicle component is attached to an associated center console between a pair of associated front seats.

11. The apparatus of claim 8 wherein:
the vehicle component is an armrest having an outer surface that is suitable to support at least a portion of an associated vehicle occupant's arm.

12. The apparatus of claim 8 wherein:
the cup holder comprises a sidewall structure that: extends from the beverage container support surface; and, defines a cavity for use in receiving the associated beverage container;
the cavity is formed at least partially in the vehicle component; and,
the cavity is for use in receiving: the associated beverage container; the first relatively larger associated digital media player; and, the second relatively smaller associated digital media player.

13. The apparatus of claim 12 wherein:
the cup holder further comprises: first and second tabs extending from the sidewall structure toward a center of the cavity, each tab having a beverage container contact surface for use in contacting the associated beverage container to hold the associated beverage container within the cavity; and,
wherein a first portion of the first relatively larger associated digital media player is positionable between the first and second tabs to hold the first relatively larger associated digital media player in the upright position.

14. The apparatus of claim 13 wherein:
the cup holder further comprises: third and fourth tabs extending from the sidewall structure toward a center of the cavity, each tab having a beverage container contact surface for use in contacting the associated beverage container to hold the associated beverage container within the cavity;
wherein the third and fourth tabs are positioned substantially on the opposite side of the cavity from the first and second tabs; and,
wherein a second portion of the first relatively larger associated digital media player is positionable between the third and fourth tabs to hold the first relatively larger associated digital media player in the upright position.

15. The apparatus of claim 14 wherein:
the first relatively larger associated digital media player covers the slot when the first relatively larger associated digital media player is supported to the beverage container support surface.

16. A method comprising the steps of:
(A) providing a cup holder comprising: a beverage container support surface for use in supporting an associated beverage container; and, a slot formed in the beverage container support surface;
(B) supporting a relatively larger digital media player to the beverage container support surface in an upright position;
(C) supporting a relatively smaller digital media player within the slot in an upright position;
wherein if step (B) is performed before step (C), then before step (C) and after step (B) the method comprises the step of: removing the relatively larger digital media player from the cup holder; and,
wherein if step (C) is performed before step (B), then before step (B) and after step (C) the method comprises the step of: removing the relatively smaller digital media player from the cup holder.

17. The method of claim 16 wherein:
step (A) comprises the steps of: providing the cup holder to be attached to a vehicle component that is accessible within the passenger compartment of a vehicle; and, providing the cup holder with a sidewall structure that: extends from the beverage container support surface; and, defines a cavity for use in receiving the associated beverage container;
step (B) comprises the step of: inserting the relatively larger digital media player into the cavity; and,
step (C) comprises the step of: inserting the relatively smaller digital media player into the cavity.

18. The method of claim 17 wherein:
step (A) comprises the step of: providing the cup holder with first and second tabs extending from the sidewall structure toward a center of the cavity, each tab having a beverage container contact surface for use in contacting the associated beverage container to hold the associated beverage container within the cavity; and,
step (B) comprises the step of: positioning a first portion of the first relatively larger digital media player between the first and second tabs to hold the first relatively larger digital media player in the upright position.

19. The method of claim 18 wherein:
step (A) comprises the step of: providing the cup holder with third and fourth tabs extending from the sidewall structure toward a center of the cavity, each tab having a beverage container contact surface for use in contacting the associated beverage container to hold the associated beverage container within the cavity; and,
step (B) comprises the step of: positioning a second portion of the first relatively larger digital media player between the third and fourth tabs to hold the first relatively larger digital media player in the upright position.

20. The method of claim 19 wherein:
step (B) comprises the step of: covering the slot with the first relatively larger digital media player covers the slot when the first relatively larger digital media player is supported to the beverage container support surface.
